(19) United States
(12) Patent Application Publication
(10) Pub. No.: US 2006/0058441 A1
(43) Pub. Date: Mar. 16, 2006

(54) Polyester fibers, their production and their use

(75) Inventors: Rex Delker, Wehringen (DE); Hans-Joachim Bruning, Augsburg (DE)

Correspondence Address: CONNOLLY BOVE LODGE & HUTZ, LLP, P O BOX 2207, WILMINGTON, DE, 19899, US

(73) Assignee: Teijin Monofilament Germany GmbH, Bobingen (DE)

(21) Appl. No.: 11/211,221

(22) Filed: Aug. 25, 2005

(30) Foreign Application Priority Data
Aug. 28, 2004 (DE) 10 2004 041 755.5

(51) Int. Cl. C08K 3/22; C08K 3/34

(52) U.S. Cl. 524/430; 524/492; 524/497

(57) ABSTRACT

Described are fibers comprising aliphatic-aromatic polyester, hydrolysis stabilizer and spherical particles of oxides of silicon, of aluminum and/or of titanium having an average diameter of not more than 100 nm. The polyester fibers possess excellent bending fatigue resistance, give distinctly reduced abrasion and are useful for producing screens or other industrial fabrics.

The present invention concerns polyester fibers having high bending fatigue resistance, especially monofilaments useful in screens or conveyor belts for example.

It is known that polyester fibers, especially monofilaments for industrial applications, are in most cases subjected to high mechanical and/or thermal stressors in use. In addition, there are in many cases stressors due to chemical and other ambient influences, to which the material has to offer adequate resistance. As well as adequate resistance to all these stressors, the material has to possess good dimensional stability and constancy of its stress-strain properties over very long use periods.

One example of industrial applications imposing the combination of high mechanical, thermal and chemical stresses is the use of monofilaments in filters, screens or as conveyor belts. This use requires a monofilament material possessing excellent mechanical properties, such as high initial modulus, breaking strength, knot strength and loop strength and also high abrasion resistance coupled with a high hydrolysis resistance in order that it may withstand high stresses encountered in its use and in order that the screens or conveyor belts may have an adequate use life.

Molding compositions possessing high chemical and physical resistance and their use for fiber production are known. Polyesters are widely used materials for this purpose. It is also known to combine these polymers with other materials, for example in order to achieve a specific degree of abrasion resistance.

Industrial manufacturers, such as paper makers or processors, utilize filters or conveyor belts in operations taking place at elevated temperatures and in hot moist environments. Polyester-based manufactured fibers have a proven record of good performance in such environments, but when used in hot moist environments polyesters are vulnerable to mechanical abrasion as well as hydrolytic degradation.

Abrasion can have a wide variety of causes in industrial uses. For instance, the sheet-forming wire screen in papermaking machines is in the process of dewatering the paper slurry pulled over suction boxes, and this results in enhanced wear of the wire screen. At the dry end of the papermaking machine, wire screen wear occurs as a consequence of speed differences between the paper web and the wire screen surface and between the wire screen surface and the surface of the drying drums. Fabric wear due to abrasion also occurs in other industrial fabrics, for instance in transportation belts due to dragging across stationary surfaces, in filter fabrics due to the mechanical cleaning and in screen printing fabrics due to the movement of a squeegee across the screen surface.

Adding fillers to improve the mechanical properties of fibers is known per se.

GB-A-759,374 describes the production of artificial fibers and films having improved mechanical properties. The claimed process is characterized by the use of very finely divided metal oxides in the form of aerosols. The particle size shall be not more than 150 nm. Viscose, polyacrylonitrile and polyamides are mentioned as examples of polymers.

EP-A-1,186,628 discloses a polyester raw material comprising finely dispersed silica gels. The individual particles have diameters of up to 60 nm and aggregates, if present, are not more than 5 μm in size. The filler is said to lead to polyester fibers having improved mechanical properties, improved color and improved handleability. The reference is unforthcoming about applications for these polyester fibers.

U.S. Pat. No. 6,544,644 (which corresponds to WO-A-01/02,629) describes monofilaments useful, inter alia, in paper-making machines. The description part refers mainly to polyamide monofilaments; polyester raw materials are also mentioned in very general terms. The monofilaments described are characterized by the presence of nanoscale inorganic materials. These provide enhanced resistance to abrasion.

EP-A-1,199,389 describes an ethylene glycol dispersion comprising aggregates of ceramic nanoparticles which are useful for producing high-strength and high-transparency polyester moldings.

JP-A-02/099,606 discloses a fiber having improved anti-microbial properties which comprises finely divided zinc oxide/silicon dioxide particles.

JP-A-02/210,020 discloses a light-resistant polyester fiber which comprises finely divided cerium oxide.

Prior art proposals involving the use of nanoscale fillers lead to fibers having improved mechanical properties. In general, however, the addition of a filler leads not only to the desired improvement in some properties but at the same time also to a deterioration in others.

It has now been found that, surprisingly, selected hydrolysis-stabilized polyester raw materials comprising certain nanoscale fillers possess distinctly improved abrasion resistance compared with unmodified polyester raw materials without their dynamic fatigue resistance, expressed by the bending fatigue resistance, being significantly reduced by the use of a filler; in fact, it may even be increased. This performance profile was observed on selected polyester raw materials.

Against the background of this prior art, the present invention has for its object to provide filled polyester fibers which, as well as excellent abrasion resistance, possess dynamic fatigue resistances which are comparable to or even better than those of unfilled polyester fibers.

The present invention further has for its object to provide transparent fibers having high abrasion resistance and excellent dynamic fatigue resistance.

The invention provides fibers comprising aliphatic-aromatic polyester, at least one hydrolysis stabilizer and spherical particles of oxides of silicon, of aluminum and/or of titanium having an average diameter of not more than 100 nm.

Preference is given to polyester fibers having a free carboxyl group content of not more than 3 meq/kg.

These polyester fibers comprise an agent to cap free carboxyl groups, for example a carbodiimide and/or an epoxy compound.

Polyester fibers thus endowed are stabilized to hydrolytic degradation and are particularly suitable for use in hot moist environments, especially in paper-making machines or as filters.

Any fiber-forming polyester can be used as long as it comprises aliphatic and aromatic groups and is formable in the melt. Aliphatic groups are in the context of this description also to be understood as meaning cycloaliphatic groups.

These thermoplastic polyesters are known per se. Examples thereof are polybutylene terephthalate, poly-hexanedimethyls terephthalate, polyethylene naphthalate or especially polyethylene terephthalate. Building blocks of fiber-forming polyesters are preferably diols and dicarboxylic acids or appropriately constructed oxyl carboxylic acids. The main acid constituent of polyesters is terephthalic acid or cyclohexane-dicarboxylic acid, but other aromatic and/or aliphatic or cycloaliphatic dicarboxylic acids may be suitable as well, preferably para- or trans-disposed aromatic compounds, for example 2,6-naphthalenedicarboxylic acid or 4,4′-biphenyldicarboxylic acid, and also isophthalic acid. Aliphatic dicarboxylic acids, such as adipic acid or sebacic acid for example, are preferably used in combination with aromatic dicarboxylic acids.

Useful dihydric alcohols typically include aliphatic and/or cycloaliphatic diols, for example ethylene glycol, propanediol, 1,4-butanediol, 1,4-cyclohexanedimethanol or mixtures thereof. Preference is given to aliphatic diols which have two to four carbon atoms, especially ethylene glycol; preference is further given to cycloaliphatic diols, such as 1,4-cyclohexanedimethanol.

Preference is given to using polyesters comprising structural repeat units derived from an aromatic dicarboxylic acid and an aliphatic and/or cycloaliphatic diol.

Preferred thermoplastic polyesters are especially selected from the group consisting of polyethylene terephthalate, polyethylene naphthalate, polybutylene naphthalate, polypropylene terephthalate, polybutylene terephthalate, polycyclohexanedimethanol terephthalate, or a copolycondensate comprising polybutylene glycol, terephthalic acid and naphthalenedicarboxylic acid units.

The polyesters used according to the present invention typically have solution viscosities (IV values) of not less than 0.60 dl/g, preferably of 0.60 to 1.05 dl/g and more preferably of 0.62-0.93 dl/g (measured at 25° C. in dichloroacetic acid (DCE)).

The nanoscale spherical oxides of silicon, of aluminum and/or of titanium used according to the present invention endow polyester fibers with excellent abrasion resistance without adversely affecting the dynamic properties, expressed by the bending fatigue resistance.

Preference is given to using spherical silicon dioxide.

The nanoscale spherical oxides of silicon, of aluminum and/or of titanium used according to the present invention typically have median (D₅₀) average particle diameters of not more than 50 nm, preferably of not more than 30 nm and more preferably in the range from 10 to 25 nm.

The polyester raw materials filled and needed to produce the fibers of the present invention can be produced in various ways. For instance, polyester, hydrolysis stabilizer and filler and also if appropriate further additives can be mixed in a mixing assembly, for example in an extruder, by melting the polyester and the composition is then fed directly to the spinneret die or the composition is granulated and spun in a separate step. The pellet obtained may if appropriate also be spun as a masterbatch together with additional polyester. It is also possible to add the nanoscale fillers before or during the polycondensation of the polyester.

Suitable nanoscale fillers are commercially obtainable. For example, the Nyacol® products from Nano Technologies, Inc., Ashland, Mass., USA can be used.

The level of nanoscale spherical filler in the fiber of the present invention can vary within wide limits, but is typically not more than 5% by weight, based on the mass of the fiber. The level of nanoscale spherical filler is preferably in the range from 0.1% to 2.5% by weight and in particular in the range from 0.5% to 2.0% by weight.

The identities and amounts of the components a) and b) are preferably chosen so that transparent products are obtained. Unlike polyamides, the polyesters used according to the present invention are notable for transparency. It has been determined that, surprisingly, the nanoscale spherical fillers have no adverse effect on transparency. By contrast, the addition of just about 0.3% by weight of non-nanoscale titanium dioxide (delusterant) causes the fiber to turn completely white.

It has further been determined that, surprisingly, the abrasion resistance of the fibers according to the present invention can be still further enhanced by the addition of polycarbonate. The amount of polycarbonate is typically up to 5% by weight, preferably in the range from 0.1% to 5.0% by weight and more preferably in the range from 0.5% to 2.0% by weight, based on the total mass of the polymers.

Fibers are in the context of this description to be understood as meaning any desired fibers.

Examples thereof are filaments or staple fibers which consist of a plurality of individual fibers, but are monofilaments in particular.

The polyester fibers of the present invention can be produced by conventional processes.

The present invention also provides a process for producing the above-defined fibers, the process comprising the measures of:
i) mixing polyester pellet with spherical particles of oxides of silicon, of aluminum and/or of titanium having an average diameter of not more than 100 nm,
ii) extruding the mixture comprising polyester and spherical particles through a spinneret die,
iii) withdrawing the resulting filament, and
iv) if appropriate drawing and/or relaxing the resulting filament.

The present invention also provides a process for producing the above-defined fibers, the process comprising the measures of:
v) feeding an extruder with polyester pellet mixed before or during the polycondensation with polyester pellet with spherical particles of oxides of silicon, of aluminum and/or of titanium having an average diameter of not more than 100 nm,
ii) extruding the mixture comprising polyester and spherical particles through a spinneret die,
iii) withdrawing the resulting filament, and
iv) if appropriate drawing and/or relaxing the resulting filament.

The hydrolysis stabilizer may already be present in the polyester raw material, or be added before and/or after spinning.

Preferably, the polyester fibers of the present invention are subjected to single or multiple drawing in the course of their process of production.

It is particularly preferable to produce the polyester fibers using a polyester produced by solid state condensation.

The polyester fibers of the present invention can be present in any desired form, for example as multifilaments, as staple fibers or especially as monofilaments.

The linear density of the polyester fibers according to the present invention can likewise vary within wide limits. Examples thereof are 100 to 45 000 dtex and especially 400 to 7000 dtex.

Particular preference is given to monofilaments whose cross-sectional shape is round, oval or n-gonal, where n is not less than 3.

The polyester fibers according to the present invention can be produced using a commercially available polyester raw material. A commercially available polyester raw material will typically have a free carboxyl group content in the range from 15 to 50 meq/kg of polyester. Preference is given to using polyester raw materials produced by solid state condensation; their free carboxyl group content is typically in the range from 5 to 20 meq/kg and preferably less than 8 meq/kg of polyester.

However, the polyester fibers of the present invention can also be produced using a polyester raw material which already comprises the nanoscale spherical filler. The polyester raw material is produced by adding the filler during the polycondensation and/or to at least one of the monomers.

After the polyester melt has been forced through a spinneret die, the hot strand of polymer is quenched, for example in a quench bath, preferably in a water bath, and subsequently wound up or taken off. The takeoff speed is greater than the ejection speed of the polymer melt.

The polyester fiber thus produced is subsequently preferably subjected to an afterdrawing operation, more preferably in a plurality of stages, especially to a two- or three-stage afterdrawing operation, to an overall draw ratio in the range from 3:1 to 8:1 and preferably in the range from 4:1 to 6:1.

Drawing is preferably followed by heat setting, for which temperatures in the range from 130 to 280° C. are employed; length is maintained constant, slight after-drawing is effected or shrinkage of up to 30% is allowed.

It has been determined to be particularly advantageous for the production of the polyester fibers of the present invention to operate at a melt temperature in the range from 285 to 315° C. and at a jet stretch ratio in the range from 2:1 to 6:1.

The takeoff speed is customarily 10-80 m per minute.

The polyester fibers of the present invention, as well as nanoscale spherical filler, may comprise further auxiliary materials. Besides the hydrolysis stabilizer already mentioned, examples of further auxiliaries are processing aids, antioxidants, plasticizers, lubricants, pigments, delusterants, viscosity modifiers or crystallization accelerants.

Examples of processing aids are siloxanes, waxes or long-chain carboxylic acids or their salts, aliphatic, aromatic esters or ethers.

Examples of antioxidants are phosphorus compounds, such as phosphoric esters, or sterically hindered phenols.

Examples of pigments or delusterants are organic dye pigments or titanium dioxide.

Examples of viscosity modifiers are polybasic carboxylic acids and their esters or polyhydric alcohols.

The fibers of the present invention can be used in all industrial fields. They are preferably employed for applications where increased wear due to mechanical stress is likely. Examples thereof are the use in screens or conveyor belts. These uses likewise form part of the subject matter of the present invention.

The polyester fibers of the present invention are preferably used for producing sheetlike structures, in particular woven fabrics used in screens.

A further use for the polyester fibers of the present invention in the form of monofilaments concerns their use as conveyor belts or as components of conveyor belts.

Particular preference is given to uses for the fibers of the present invention in screens which are wire screens and intended for use in the dry end of papermaking machines.

These uses likewise form part of the subject matter of the present invention.

The present invention further provides for the use spherical particles of inorganic oxides having a median diameter of not more than 100 nm for producing fibers, especially monofilaments, having high bending fatigue resistance.

The examples which follow illustrate the invention without limiting it.

General Operating Method for Examples 1, V1 and V2 (Comparative)

Polyethylene terephthalate (PET) and if appropriate hydrolysis stabilizer were mixed in an extruder, melted and spun through a 20 hole spinneret die having a hole diameter of 1.0 mm at a feed rate of 488 g/min and a takeoff speed of 31 m/min to form monofilaments, triply drawn to draw ratios of 4.95:1, 1.13:1 and 0.79:1 and also heat-set in a hot air duct at 255° C. with shrinkage being allowed. The overall draw ratio was 4.52:1. Monofilaments having a diameter of 0.40 mm were obtained.

The PET used was a type where different amounts of nanoscale spherical silicon dioxide had been added in the course of the polycondensation stage. The median (D₅₀) diameter of the nanoscale filler was 50 nm.

The hydrolysis stabilizer used was a carbodiimide (Stabaxol® 1, from Rheinchemie).

General Operating Method for Examples 3-7 and V3 (Comparative)

Monofilaments were produced as described in the operating method for Examples 1, V1 and V2. Different nanoscale fillers were used as well as a hydrolysis stabilizer.

The monofilaments of Example 7 were a warp type having a (compared with the monofilaments of Example 4) comparatively steep trajectory in the stress-strain diagram and comparatively low breaking extension. This performance profile was achieved through appropriate drawing and relaxing of the monofilaments.

Monofilament according to Example 4: triple drawing to draw ratios of 5.0:1, 1.1:1 and 0.9:1 (overall draw ratio: 4.8:1) and heat setting at 185° C. with shrinkage allowed.

Monofilament according to Example 7: triple drawing to draw ratios of 4.8:1, 1.2:1 and 1.04:1 (overall draw ratio: 5.7:1) and heat setting in third drawing stage at 250° C.

Fiber properties were determined as follows:
linear density to DIN EN/ISO 2060
   tensile strength to DIN EN/ISO 2062
breaking extension to DIN EN/ISO 2062
   hot air shrinkage to DIN 53843

Dynamic bending test (bending strength): the sample was placed between two metal jaws having a defined bending edge and was bent left and right through an angle of 60° by a rotating movement (double strokes 146/min) in a rotating head until broken. In the process, the sample was subjected to a pre-tensioning force of 0.675 cN/dtex. The metal jaws were spaced apart by a distance equal to the diameter of the sample. The bending edge of the metal jaws was exactly predetermined by a fixed radius. The number of bending cycles to fracture was determined.

Blade scuff test: The sample was scuffed over a length of 70 mm over a ceramic capillary tube in a double stroke movement (60 double strokes/min). In the process, the sample was subjected to a pre-tensioning force of 0.135 cN/dtex. The number of double strokes to fracture was determined.

Tables 1 and 2 below list the composition and also the properties of the monofilaments.

TABLE 1

| | | | Fiber | | | | | Dynamic | Blade |
|---|---|---|---|---|---|---|---|---|---|
| | | Hydrolysis | linear | Fiber | Tensile | Breaking | Hot air | bending | scuff |
| Example | PET raw | stabilizer | density | diameter | strength | extension | shrinkage | test | test |
| No. | material¹⁾ | [wt %] | [dtex] | [μm] | [cN/tex] | (%) | (%) | (cycles) | (cycles) |
| V1 | without | — | 1735 | 399 | 41.0 | 40.0 | 2.9 | 1496 | 45671 |
| | filler | | | | | | | | |
| 1 | 0.3% of | 1.3 | 1736 | 401 | 39.7 | 37.5 | 3.9 | 4709 | 69477 |
| | filler | | | | | | | | |
| V2 | 0.3% of | — | 1735 | 398 | 40.2 | 37.0 | 3.1 | 1777 | 64857 |
| | filler | | | | | | | | |

¹⁾The monofilaments obtained were transparent

TABLE 2

| | | | Dynamic | Blade |
|---|---|---|---|---|
| | | Filler | bending | scuff |
| Example | | quantity | test | test |
| No. | Filler | [% by weight] | (cycles) | (cycles) |
| 3 | spherical | 0.4 | 66736 | 140233 |
| | silicon | | | |
| | dioxide | | | |
| | 20 nm | | | |
| 4 | spherical | 0.4 | 114989 | 181223 |
| | silicon | | | |
| | dioxide | | | |
| | 50 nm | | | |
| 5 | spherical | 0.4 | 90985 | 142343 |
| | silicon | | | |
| | dioxide | | | |
| | 100 nm | | | |
| 6 | spherical | 0.04 | 16238 | 65822 |
| | aluminum | | | |
| | oxide | | | |
| | 50 nm | | | |
| 7 | spherical | 0.4 | 49673 | 102986 |
| | silicon | | | |
| | dioxide | | | |
| | 50 nm | | | |
| V3 | nanoclay | 0.1 | 272 | 19929 |
| | (not | | | |
| | spherical) | | | |

1. A fiber comprising aliphatic-aromatic polyester, at least one hydrolysis stabilizer and spherical particles of oxides of silicon, of aluminum and/or of titanium having an average diameter of not more than 100 nm.

2. The fiber according to claim 1 wherein the polyester comprises structural repeat units derived from an aromatic dicarboxylic acid and an aliphatic and/or cycloaliphatic diol.

3. The fiber according to claim 1 wherein the aliphatic-aromatic polyester has a free carboxyl group content of not more than 3 meq/kg.

4. The fiber according to claim 3 wherein the hydrolysis stabilizer is at least one carbodiimide and/or at least one epoxy compound.

5. The fiber according to claim 1 wherein the spherical particles consist of silicon dioxide.

6. The fiber according to claim 1 wherein the oxide of silicon, of aluminum and/or of titanium has an average diameter of not more than 50 nm.

7. The fiber according to claim 1 wherein the amount of oxide of silicon, of aluminum and/or of titanium is in the range from 0.1% to 5% by weight, based on the mass of the fiber.

8. The fiber according to claim 1 which, as well as the aliphatic-aromatic polyester, comprises from 0.1% to 5% by weight, based on the total mass of the polymers, of polycarbonate.

9. The fiber according to claim 1 which is transparent.

10. The fiber according to claim 1 which is a monofilament.

11. A process for producing the fibers according to claim 1, the process comprising the measures of:
i) mixing polyester pellet with spherical particles of oxides of silicon, of aluminum and/or of titanium having an average diameter of not more than 100 nm,
ii) extruding the mixture comprising polyester and spherical particles through a spinneret die,
iii) withdrawing the resulting and/or relaxing the resulting filament, and
iv) optionally drawing and/or relaxing the resulting filament.

12. A process for producing the fibers according to claim 1, the process comprising the measures of:
v) feeding an extruder with polyester pellet mixed before or during the polycondensation with polyester pellet with spherical particles of oxides of silicon, of aluminum and/or of titanium having an average diameter of not more than 100 nm,
ii) extruding the mixture comprising polyester and spherical particles through a spinneret die,
iii) withdrawing the resulting filament, and
iv) optionally drawing and/or relaxing the resulting filament.

13. The process according to claim 11, wherein the polyester fiber is subjected to single or multiple drawing.

14. The process according to claim 11, wherein the polyester fiber is produced using a polyester produced by solid state condensation.

15-17. (canceled)

18. The fiber according to claim 1 wherein the polyester comprises structural repeat units derived from polyethylene terephthalate repeat units alone or combined with other structural repeat units derived from alkylene glycols and aliphatic dicarboxylic acids.

19. The fiber according to claim 1 wherein the oxide of silicon, of aluminum and/or of titanium has an average diameter of not more than 30 nm.

20. The fiber according to claim 1 wherein the amount of oxide of silicon, of aluminum and/or of titanium is in the range from 1% to 2% by weight and preferably in the range from 1% to 2% by weight, based on the mass of the fiber and comprises from 0.5% to 2% by weight, based on the total mass of the polymers, of polycarbonate.

21. A screen or conveyor belt which comprises the fibers according to claim 1.

22. The screen according to claim 21 wherein the screen is a wire screen for use in the dry end of papermarking machines.

23. A process for producing fibers which comprises using spherical particles of oxides of silicon, of aluminum and/or of titanium having an average diameter of not more than 100 nm and having high bending fatigue resistance.
